(19) United States
(12) Patent Application Publication
(10) Pub. No.: US 2006/0210357 A1
(43) Pub. Date: Sep. 21, 2006

(54) Connection of a vehicle part to a vehicle body structure

(75) Inventors: Thorsten Breitfeld, Boeblingen (DE); Jochen Heinzelmann, Schoenaich (DE); Wolfgang Saeuberlich, Grafenau (DE); Bernhard Trunk, Sindelfingen (DE)

Correspondence Address: KENYON & KENYON LLP, ONE BROADWAY, NEW YORK, NY, 10004, US

(73) Assignee: DAIMLERCHRYSLER AG, Stuttgart (DE)

(21) Appl. No.: 10/545,624

(22) PCT Filed: Dec. 11, 2003
(86) PCT No.: PCT/EP03/14034

§ 371 Date: Apr. 7, 2006

(30) Foreign Application Priority Data
Feb. 14, 2003 (DE) 103 06 160.6

(51) Int. Cl. F16D 1/00

(52) U.S. Cl. 403/408.1

(57) ABSTRACT

A device is for connecting a dynamically stressed vehicle part to a vehicle body structure with the interconnection of a bearing. The bearing has a bearing core which, in the fitted state, is in bearing contact with the vehicle body structure. The device includes at least one contact point reinforcing element. Furthermore, an arrangement is for directly connecting a dynamically stressed vehicle part to a vehicle body structure without the interconnection of a bearing.

### FIELD OF THE INVENTION

The present invention relates to a device for connecting a dynamically stressed vehicle part to a vehicle body structure with the interconnection of a bearing. The present invention also relates to a bearing core and to an arrangement for directly connecting a dynamically stressed vehicle part to a vehicle body structure.

### BACKGROUND INFORMATION

Devices of the type discussed here are described, for example, in German Published Patent Application No. 199 47 759 and German Published Patent Application No. 40 11 827. They are used, for example, for connecting a subframe to a vehicle body and include a bearing with a bearing core which, in the fitted state, is secured to the vehicle bodywork by a screw connection. The bearing core has a planar end surface with which it is intended to bear over the entire surface against the vehicle bodywork or against a securing device connected thereto. However, this cannot be ensured in all cases in particular because of component and position tolerances.

Undefined and inconstant contact and support ratios at the transitions from the chassis to the vehicle body shell may result in pronounced interruptions in the profile of the dynamic stiffness of the connecting point, which may have the effect of an increased introduction of structure-borne sound into the vehicle body structure and therefore may lead to an undesirable noise behavior in the vehicle interior.

### SUMMARY

An example embodiment of the present invention may provide a device, in which a defined and reproducible connection of a vehicle part to a vehicle body structure may be ensured. An example embodiment of the present invention may provide an arrangement, in which a defined and reproducible, direct connection of a vehicle part to a vehicle body structure may be ensured without the interconnection of a bearing.

According to an example embodiment of the present invention, a device includes at least one contact point reinforcing element which is arranged and designed such that, in the event of dynamic loading of the vehicle part connected to the vehicle body structure, tilting movements of the bearing core over the bearing contact region between bearing core and vehicle body structure may be avoided, e.g., at least reduced in comparison to conventional devices. The reinforcement, realized by the contact point reinforcing element, of the connecting point between bearing core and vehicle body structure may enable a homogeneous and reliable profile of stiffness of the connecting point to be ensured, with the result that force peaks and excessive introductions of structure-borne sound, which are also referred to as whining noises, into the vehicle body structure may be avoided. The interior acoustics of the vehicles in comparison to one another may be less scattered than in the case of vehicles, in which the vehicle part is connected to the vehicle body structure by conventional devices.

The abovementioned vehicle part may be, for example, a subframe or an assembly holder which is connected to the vehicle body shell by at least one device hereof. If the vehicle part is a subframe, on which, inter alia, the chassis of the vehicle is secured, it may be connected to the vehicle body structure by a plurality of devices hereof.

The contact point reinforcing element may be arranged in the bearing contact region between bearing core and vehicle body structure, so that overall a compact, space-saving construction may be realized.

According to an exemplary embodiment of the device, the bearing core may have a bearing contact surface which, in the fitted state of the bearing, is pressed with the aid of a clamping device onto a mating contact surface provided on the vehicle body structure, and the contact point reinforcing element may be arranged at a lateral distance from the abutting contact surfaces. The frictional connection, which may be realized by the clamping device, between bearing core and vehicle body structure may be produced—e.g., exclusively—via the bearing contact surface and the mating contact surface. The clamping force which is produced by the clamping device and causes the bearing core in the vehicle body structure to be pressed against each other therefore acts exclusively on the contact surfaces. That is, leaving out or omitting the contact point reinforcing element or a functional failure or a reduction in function of the same may not result in the clamping connection being undone, but may merely have the consequence of an inhomogeneous stiffness profile of the bearing point.

The clamping device may be formed by at least one screw which reaches through a passage opening in the bearing core and may be screwed to the vehicle body structure or to a retaining element provided or arranged thereon.

The contact point reinforcing element may be arranged in a depression provided in the bearing core or the vehicle body structure and, in the non-fitted state of the bearing, may protrude over the bearing contact surface or the mating contact surface. The depression may be used, e.g., for centering or precisely positioning the contact point reinforcing element on the bearing core or the vehicle body structure.

If the contact point reinforcing element is deformable, the depression may be furthermore used, when the bearing core is pressed onto the vehicle body structure, to receive material of the contact point reinforcing element that has been displaced as a consequence of the compression of the contact point reinforcing element, so that it is not pressed in an uncontrolled manner into a gap between bearing core and vehicle body structure that may be present because of component and/or position tolerances.

The profile of the depression may be matched to the outer contour of the bearing core, e.g., the contour of the depression may correspond at least substantially to the outer contour of the bearing core, with the distance of the depression from the edge of the bearing core, e.g., being constant over its entire length.

The depression may be encircling, e.g., self-contained. As an alternative, it is possible for the depression to be closed at its ends by a respective end wall. The depression may be formed by a groove, with the result that it is of annular arrangement or in the shape of a section of a ring. A common feature may be that the length of the contact point reinforcing element is the same size as or slightly smaller than the length of the depression, with the result that the contact point reinforcing element may not be displaced within the depression, but rather may be positioned in a fixed position. Provision may be made for the contact point reinforcing element to surround the bearing contact surface or the mating contact surface.

The contact point reinforcing element may be only placed into the depression, which may simplify an exchange of the contact point reinforcing element. However, the contact point reinforcing element may also be pressed and/or bonded into the depression.

The contact point reinforcing element may be deformable at least in the direction of the forces acting, in the fitted state of the bearing, on the bearing contact surface and the mating contact surface. The deformability may be realized by a corresponding selection of material and/or by a corresponding structural configuration of the contact point reinforcing element.

The contact point reinforcing element may be less stiff than the bearing core and the vehicle body structure in the connecting region thereof. As a result, it may be ensured that, when the bearing core is fitted onto the vehicle body structure with the bearing contact being formed, the contact point reinforcing element is deformed/compressed until the desired frictional connection, which may be realized by the clamping device, between bearing core and vehicle body structure is produced.

The contact point reinforcing element may have vibration-damping properties. For example, the contact point reinforcing element may be composed of a material which has these properties. As an alternative, the contact point reinforcing element may also be of multipart design. The contact point reinforcing element may be arranged such that vibrations from the driving operation may be isolated as far as possible from the vehicle body structure in order to improve the noise behavior in the vehicle interior.

The contact point reinforcing element may be produced, for example, from the same material as a cylinder head gasket. The material of the contact point reinforcing element may not have a settling tendency, with the result that the function of the contact point reinforcing element may be ensured over a desired period of time. The contact point reinforcing element may be formed, for example, of metal, a plastic, e.g., an elastomer, a combination of the two abovementioned materials, etc.

The contact point reinforcing element may be annular and may be arranged such that it surrounds the bearing contact surface of the bearing core or the mating contact surface of the vehicle body structure.

The device hereof may be used in the lightweight construction (e.g., body sheet region). An improved impedance and stiffness which may be realized by the contact point reinforcing element in the connecting region of the bearing core to the vehicle body structure.

According to an example embodiment of the present invention, a bearing core may include a depression for accommodating a contact point reinforcing element as described above in its end surface interacting with the vehicle body structure. The bearing core may have a simple and therefore cost-effective construction and, in combination with the contact point reinforcing element arranged thereon, may improve the introduction of vibrations into the vehicle body structure.

According to an example embodiment of the present invention, an arrangement may be provided for directly connecting a dynamically stressed vehicle part to a vehicle body structure without the interconnection of a bearing. The vehicle part, in the fitted state, may be in direct bearing contact with the vehicle body structure. The arrangement may include at least one contact point reinforcing element, as described above, which may reinforce the connecting point between vehicle part and vehicle body structure, so that a homogeneous and reliable profile of stiffness of the connecting point may be ensured.

A vehicle part or a vehicle body structure may include a depression for accommodating a contact point reinforcing element as described above.

Example embodiments of the present invention are described in more detail below with reference to the appended Figures.

### BRIEF DESCRIPTION OF THE DRAWINGS

FIG. 1 is a schematic diagram of a device according to an exemplary embodiment of the present invention in a fitted state.

FIGS. 2 to 6 each illustrate an exemplary embodiment of a bearing core in a plan view of one of its end surfaces.

### DETAILED DESCRIPTION

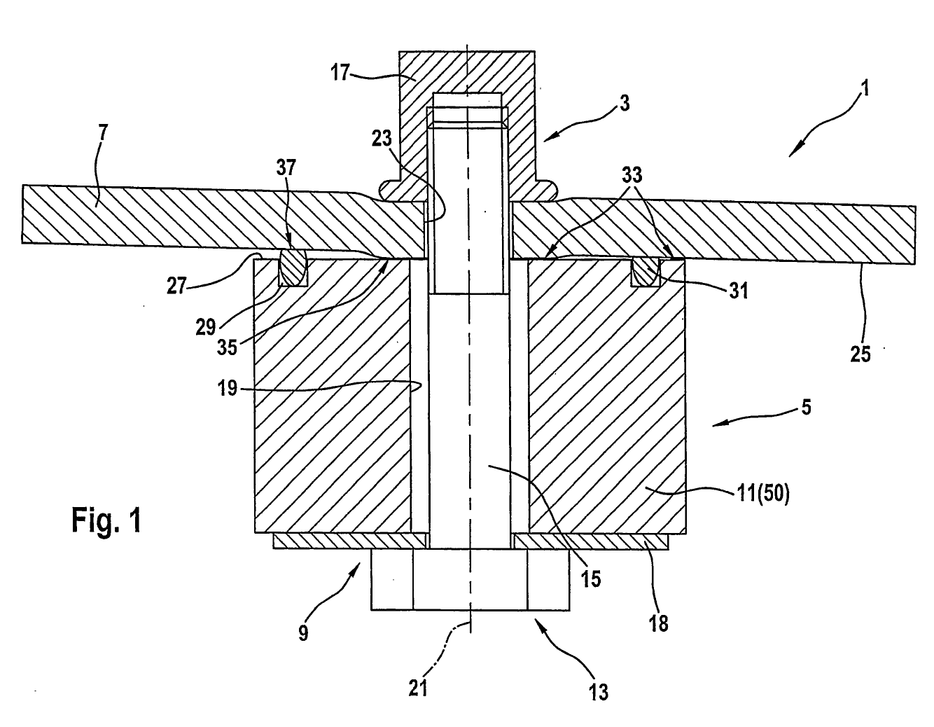

FIG. 1 illustrates a cutout of a vehicle body structure 1 on which, in the region of a connecting point 3, a vehicle part, for example a subframe or an assembly holder, is secured with the interconnection of a bearing 5. Of the vehicle body structure 1, only a sheet part 7 of a floor assembly or a support connected to the latter is illustrated.

The bearing 5 is part of a device 9 for connecting the vehicle part to the vehicle body structure 1 and includes a bearing core 11, which is coupled to the vehicle part to be connected or is formed thereon, and a clamping device 13 for securing the bearing core 11 to the vehicle body structure 1. The clamping device 13 may be formed by a fastening screw 15 and a retaining element 17 to which the fastening screw 15 may be screwed. Furthermore, a washer 18 is provided and is arranged between the head of the fastening screw 15 and the bearing core 11.

The bearing core 11 has a passage opening 19 which extends coaxially with the longitudinal central axis 21 of the bearing core 11. The passage opening 19 is used for passing the fastening screw 15 through, the free end of which screw, in the fitted state, reaches through a passage opening 23 in the sheet part 7 and is screwed to the retaining element 17 arranged on that side of the sheet part 7 which is opposite the bearing core 11. As an alternative, it is also possible for a threaded bore to be provided in the vehicle body structure 1, into which the fastening screw 15 is screwed.

The bearing core 11, which may be pressed on the end side onto a substantially planar flat side 25 of the sheet part 7, has a plane end surface 27 in which an encircling, annular depression 29 is provided. The depression 29 is arranged in the vicinity of the outer edge region of the bearing core 11 and may have a rectangular cross section, e.g., the side walls of the depression 29 extend parallel to one another and perpendicularly with respect to the planar bottom of the depression 29. The shape of the depression 29 is not restricted to that illustrated in FIG. 1, but rather may be varied.

An annular, deformable contact point reinforcing element 31 is placed into the depression 29 and, at least in the non-fitted state of the bearing 5, protrudes over the end surface 27 of the bearing core 11. The depression 29 in the form of a groove is used, inter alia, for centering and exactly positioning the contact point reinforcing element 31 on the bearing core 11. The contact point reinforcing element 31 may be used to ensure reproducible contact and bearing ratios between bearing core 11 and sheet part 7 and is less stiff than the bearing core 11 and the vehicle body structure 1 in the bearing contact region thereof at the connecting point 3.

When the vehicle part is fitted to the vehicle body structure 1, the bearing core 11 is moved on the end side toward the flat side 25 when the fastening screw 15 is tightened. In the process, the contact point reinforcing element 31 which protrudes over the bearing core end surface 27 is deformed such that it bears over the full area against the sheet part 7, as illustrated in FIG. 1. In the case of larger deformations of the contact point reinforcing element 31, its displaced material—at least for the most part—is accommodated in the depression 29. When the contact point reinforcing element 31 is compressed, the depression 29 may furthermore prevent a lateral yielding of the same and may keep it in its predetermined position. The deformation of the contact point reinforcing element 31 causes the bearing core end surface 27 to approach the flat side 25 of the sheet part 7 until a bearing contact is formed between bearing core 11 and sheet part 7.

In the exemplary embodiment illustrated in FIG. 1, the flat side 25 of the sheet part 7 and the end surface 27 of the bearing core 11 do not extend exactly parallel to each other because of component and position tolerances. This has the effect that, when the fastening screw 15 is tightened at a required torque, the bearing core 11 is in bearing contact with the sheet part 7 in its edge region arranged—according to the illustration of FIG. 1—on the right of the longitudinal center axis 21 and, due to deformations of the sheet part 7, in its central region while, at least in the region arranged on the left of the longitudinal center axis 21, a gap remains between bearing core 11 and sheet part 7 that is bridged by the contact point reinforcing element 31. Most of the bearing contact surface 33 of the bearing core 11 on the mating contact surface 35 of the sheet part 7 is essentially annular and extends around the passage opening 19 in the bearing core 11. The remaining part of the bearing contact surface 33 is formed—according to the illustration of FIG. 1—on the edge of the bearing core 11 on the right of the longitudinal center axis 21.

It should be appreciated that the frictional connection, which is realized by fastening screw 15, between bearing core 11 and sheet part 7 may take place exclusively via the bearing contact between these parts. The contact point reinforcing element 31 may have virtually no influence on the frictional connection.

Due to the inclination of the bearing core 11 with respect to the flat side 25 of the sheet part 7, the contact point reinforcing element 31 is nonuniformly compressed. As illustrated in FIG. 1, it may be virtually fully pressed into the groove-shaped depression 29 in the region in the vicinity of the edge, in which there is bearing contact between bearing core 11 and sheet part 7, while it may be much less deformed in the region located diametrically opposite, because of the gap which is present. It is illustrated in FIG. 1 that the contact point reinforcing element 31 may be deformed at least elastically and, if appropriate, also plastically until there is a connection over the full area with the sheet part 7. The bearing surface of the contact point reinforcing element 31 on the flat side 25 of the sheet part 7 is indicated by reference number 37. The contact point reinforcing element 31 may be arranged such that it bears fully over its entire length against the sheet part 7 and thus spans the gap between bearing core 11 and sheet part 7.

Since the contact point reinforcing element 31 spans the gap between bearing core 11 and sheet part 7, movements of the bearing core 11, e.g., tilting movements over the bearing contact point in the central region of the bearing core 11, which tilting movements are in the micrometer range, may be prevented, e.g., at least significantly diminished. By the contact point reinforcing element 31, a significant reinforcing of the contact point region may be established, with the result that pronounced interruptions in the profile of the dynamic stiffness of this connecting point 3 may be avoided. The contact point reinforcing element 31 may enable constant contact and supporting ratios between bearing core 11 and sheet part 7 to be produced.

In order to avoid tilting movements of the bearing core 11 with respect to the sheet part 7, the lateral distance—according to the illustration of FIG. 1—of the contact point reinforcing element 31 from the center of the bearing core 11 may have as large as possible. The arrangement of the depression 29 for receiving the contact point reinforcing element 31 may be selected accordingly.

As illustrated in FIG. 1, the sheet part 7 may be deformed locally when the fastening screw 15 is tightened, e.g., under the influence of the retaining element 17. However, for the functioning of the contact point reinforcing element 31, it may not matter whether the sheet part 7 or, if appropriate, the bearing core 11 is deformed because of the frictional connection between these parts. If the bearing core 11 and/or the vehicle body structure 1 is/are of such stiff or rigid configuration that it is/they are not deformed in their bearing contact region during the securing operation, a correspondingly different bearing contact may be produced.

The depression 29 may be dimensioned to be of such a size that, with exact parallel orientation of the planar end surface 27 of the bearing core 11 and of the planar flat side 25 of the sheet part 7 with respect to each other, the contact point reinforcing element 31 is fully accommodated in the depression 29, so that virtually no more action is exerted. In this regard, the bearing contact surface 33 is at maximum and is the same size as the end surface 27 of the bearing core 11.

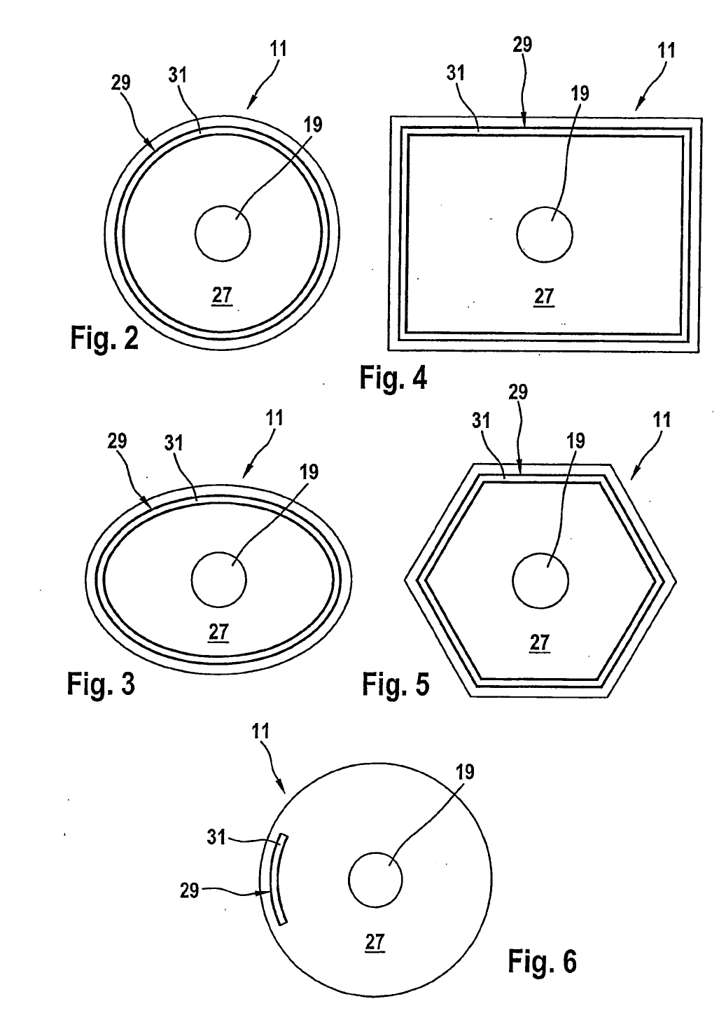

FIGS. 2 to 5 each illustrate an exemplary embodiment of the bearing core 11 in a plan view of the end surface 27 which interacts, in the fitted state, with the vehicle structure 1. The bearing core 11 illustrated in FIG. 2 has a round outer contour, the bearing core 11 illustrated in FIG. 3 has an elliptical outer contour, the bearing core 11 illustrated in FIG. 4 has a rectangular outer contour and the bearing core 11 illustrated in FIG. 5 has a hexagonal outer contour. A common feature of all of the exemplary embodiments is that they have in their center a passage opening 19, which is round, for passing the fastening screw 15 through. The bearing cores 11 each have a depression 29 which is arranged in the edge region of the end surface 27 and is matched in each case to the outer contour of the bearing core 11. That is, the depression 29 provided in the bearing core 11 illustrated in FIG. 2 has a round contour and a depression 29 in the bearing core 11 illustrated in FIG. 3 has an elliptical contour while the depression 29 of the bearing core 11 illustrated in FIG. 4 has a rectangular contour and the depression 29 in the bearing core 11 illustrated in FIG. 5 has a hexagonal contour.

A common feature of the exemplary embodiments illustrated in FIGS. 2 to 5 is that the particular depression 29 is of encircling arrangement and surrounds the passage opening 19.

The contact point reinforcing element 31 placed into the particular depression 29 has a shape matched to the shape of the depression 29, i.e., is of round, elliptical, rectangular, hexagonal design, etc. The shape of the bearing core 11, that of the depression 29 and that of the contact point reinforcing element 31 may be varied and is not restricted to the exemplary embodiments illustrated in FIGS. 2 and 5. The arrangement close to the edge of the depression 29 may precisely position the particular contact point reinforcing element 31 and, when the screw connection is tightened, may prevent the contact point reinforcing element 31 from slipping on the end surface 27 of the bearing core 11.

FIG. 6 illustrates, in plan view, a further exemplary embodiment of the bearing core 11 which differs from the bearing core 11 described with reference to FIG. 2 in that the depression 29 and the contact point reinforcing element 31 arranged therein are not of encircling configuration, but rather have the shape of a section of a ring. The contact point reinforcing element 31 is arranged at a lateral distance from the longitudinal center axis 21 of the bearing core 11 in that region of the end surface 27 which is in the vicinity of the outer edge. The contact point reinforcing element 31 protrudes over the end surface 27 of the bearing core 11 and is of such rigid arrangement that it first of all comes into bearing contact with the vehicle body structure 1 when the bearing core 11 is fitted and, when the bearing core 11 is secured, causes a tilting movement of the same, with the result that it is positioned against the vehicle body structure 1 in that region of the end surface 27 which is diametrically opposite the contact point reinforcing element 31. It may thereby be ensured that the bearing core 11 bears at least in two mutually opposite regions/points, with the result that a tilting of the bearing core 11 in this direction may be prevented. The inclination of the bearing core 11 that is caused by the contact point reinforcing element 31 may ensure reproducible bearing and contact ratios between bearing core 11 and the vehicle body structure 1.

The bearing 5 described with reference to the Figures may be designed as a rigid bearing, e.g., the bearing core 11 may occupy, for example, the entire construction space of the bearing 5. The connection of the bearing core 11 to the vehicle part is therefore rigid. The connection between bearing core 11 and the dynamically stressed vehicle part may be elastic. Exemplary embodiments of an elastic connection are conventional and are described, for example, in German Published Patent Application No. 199 47 759 and German Published Patent Application No. 40 11 827, so that a more detailed description is omitted.

The above-described contact point reinforcing element 31 may also be used in an arrangement for directly connecting the vehicle part to the vehicle body structure, in which arrangement the vehicle part, in the fitted state, is in direct bearing contact with the vehicle body structure 1. The function of the contact point reinforcing element 31 is the same as in the exemplary embodiment which is described with reference to FIG. 1 and in which the connection does not take place directly, but rather with the interconnection of the bearing 5 having a bearing core 11. The bearing core 11 illustrated in FIG. 1 may therefore be replaced by the vehicle part indicated in FIG. 1 by the reference number “50” in brackets in order to form the arrangement discussed.

1-38. (canceled)

39. A device for connecting a dynamically stressed vehicle part to a vehicle body structure, comprising:
a bearing including a bearing core in bearing contact with the vehicle body structure in a fitted state; and
at least one contact point reinforcement element adapted to reduce tilting movement of the bearing core over a bearing contact region between the bearing core and the vehicle body structure.

40. The device according to claim 39, wherein the contact point reinforcement element is adapted to be arranged in the bearing contact region between the bearing core and the vehicle body structure.

41. The device according to claim 39, further comprising a clamp device, the bearing core including a bearing contact surface, the clamp device adapted to press, in the fitted state of the bearing, the bearing contact surface onto a mating contact surface on the vehicle body structure, the contact point reinforcement element arranged at a lateral distance from the bearing contact surface and the mating contact surface.

42. The device according to claim 39, wherein the contact point reinforcement element is arranged in a depression of one of (a) the bearing core and (b) the vehicle body structure, in a non-fitted state of the bearing, the contact point reinforcement element protruding over one of (a) a bearing contact surface of the bearing core and (b) a mating contact surface of the vehicle body structure.

43. The device according to claim 42, wherein a profile of the depression is matched to an outer contour of the bearing core.

44. The device according to claim 42, wherein the depression is encircling.

45. The device according to claim 44, wherein the depression is formed by a groove.

46. The device according to claim 42, wherein the depression is dimensioned with respect to the contact point reinforcement element so that the contact point reinforcement element is accommodatable in the depression.

47. The device according to claim 39, wherein the contact point reinforcement element is deformable at least in a direction of forces that act, in the fitted state of the bearing, on a bearing contact surface of the bearing core and a mating contact surface of the vehicle body structure.

48. The device according to claim 39. wherein the contact point reinforcement element is less stiff than the bearing core and the vehicle body structure in a connection region.

49. The device according to claim 42, wherein the contact point reinforcement element extends across an entire length of the depression.

50. The device according to claim 39, wherein the contact point reinforcement element is annular.

51. The device according to claim 50, wherein the contact point reinforcement element surrounds one of (a) a bearing contact surface of the bearing core and (b) a mating contact surface of the vehicle body structure.

52. The device according to claim 39, wherein the contact point reinforcement element includes vibration-damping properties.

53. The device according to claim 39, wherein a bearing contact surface is arranged at an end side of the bearing core, the bearing core including, in a plan view of the end side, one of (a) a circular outer contour, (b) an oval outer contour, (c) a round outer contour and (d) an angular outer contour.

54. The device according to claim 39, wherein a center of the bearing core includes a through hole that extends in a direction of a longitudinal axis of the bearing core, the through hole adapted to receive a clamp device therethrough.

55. The device according to claim 54, wherein the clamp device includes a screw.

56. The device according to claim 54, wherein the contact point reinforcement element is arranged in a depression arranged in a region of a vicinity of an outer edge of an end surface of the bearing core, the contact point reinforcement element protruding over a bearing contact surface of the bearing core.

57. The device according to claim 56, wherein the end surface of the bearing core is planar.

58. The device according to claim 39, wherein end surfaces of the bearing core are plane-parallel.

59. A device, comprising:
a bearing core for a device for connecting a dynamically stressed vehicle part to a vehicle body structure, the bearing core pressable onto the vehicle body structure by an end side, the bearing core including a depression in an end surface adapted to accommodate a contact point reinforcement element.

60. A device, comprising:
an arrangement adapted to directly connect a dynamically stressed vehicle part including one of (a) a suspension subframe and (b) an assembly holder to a vehicle body structure, the vehicle part, in a fitted stated, in bearing contact with the vehicle body structure; and
at least one contact point reinforcement element adapted to reduce tilt movement of the vehicle part over a bearing contact region between the vehicle part and the vehicle body structure.

61. The device according to claim 60, wherein the contact point reinforcement element is arranged in the bearing contact region between the vehicle part and the vehicle body structure.

62. The device according to claim 60, further comprising a clamp device, the bearing core including a bearing contact surface, the clamp device adapted to press, in the fitted state of the vehicle part, the bearing contact surface onto a mating contact surface on the vehicle body structure, the contact point reinforcement element arranged at a lateral distance from the bearing contact surface and the mating contact surface.

63. The device according to claim 60, wherein the contact point reinforcement element is arranged in a depression of one of (a) the vehicle part and (b) the vehicle body structure, in a non-fitted state of the vehicle part, the contact point reinforcement element protruding over one of (a) a bearing contact surface of the vehicle part and (b) a mating contact surface of the vehicle body structure.

64. The device according to claim 63, wherein a profile of the depression is matched to an outer contour of the bearing contact surface.

65. The device according to claim 63, wherein the depression is encircling.

66. The device according to claim 65, wherein the depression is formed by a groove.

67. The device according to claim 63, wherein the depression is dimensioned with respect to the contact point reinforcement element so that the contact point reinforcement element is accommodatable in the depression

68. The device according to claim 60, wherein the contact point reinforcement element is deformable at least in a direction of forces acting, in the fitted state of the vehicle part, on a bearing contact surface of the vehicle part and a mating contact surface on the vehicle body structure.

69. The device according to claim 60, wherein the contact point reinforcement element is less stiff than the vehicle part and the vehicle body structure in a connection region.

70. The device according to claim 63, wherein the contact point reinforcement element extends across an entire length of the depression.

71. The device according to claim 60, wherein the contact point reinforcement element is annular.

72. The device according to claim 71, wherein the contact point reinforcement element surrounds one of (a) a bearing contact surface of the vehicle part and (b) a mating contact surface of the vehicle body structure.

73. The device according to claim 60, wherein the contact point reinforcement element including vibration-damping properties.

74. The device according to claim 60, wherein a bearing contact surface of the vehicle part includes a through hole adapted to receive a clamp device therethrough.

75. The device according to claim 74, wherein the clamp device includes a screw.

76. The device according to claim 74, wherein the contact point reinforcement element is arranged in a depression arranged in a region in a vicinity of an outer edge of an end surface of a bearing contact surface of the vehicle part.

77. The device according to claim 76, wherein the end surface is planar.

78. The device according to claim 60, wherein end surfaces of the vehicle part are plane-parallel.

70. A device, comprising:
a dynamically stressed vehicle part including one of (a) a suspension subframe and (b) an assembly holder, the vehicle part pressable onto a vehicle body structure, the vehicle part directly connectable to the vehicle body structure, in a fitted state, the vehicle part in bearing contact with the vehicle body structure, the vehicle part including a depression adapted to accommodate a contact point reinforcement element, the contact point reinforcement element adapted to reduce tilting movement of the vehicle part over a bearing contact region between the vehicle part and the vehicle body structure.

71. A device, comprising:
a vehicle body structure directly connectable to a dynamically stressed vehicle part including one of (a) a suspension subframe and (b) an assembly holder, the vehicle part pressable onto the vehicle body structure, the vehicle body structure directly connectable to the vehicle part, in a fitted state, the vehicle body structure in bearing contact with the vehicle part, the vehicle body structure including a depression adapted to accommodate a contact point reinforcement element, the contact point reinforcement element adapted to reduce tilting movement of the vehicle part over a bearing contact region between the vehicle part and the vehicle body structure.
